(19) United States
(12) Patent Application Publication
(10) Pub. No.: US 2007/0222872 A1
(43) Pub. Date: Sep. 27, 2007

(54) Defective pixel correction method and semiconductor device

(75) Inventor: Shinzou Satou, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/499,645

(22) Filed: Aug. 7, 2006

(30) Foreign Application Priority Data
Mar. 23, 2006 (JP) 2006-081434

(51) Int. Cl. H04N 9/64

(52) U.S. Cl. 348/246

(57) ABSTRACT

A defective pixel correction method selects, in place of a defective pixel within a pixel part of an image pickup device, a pixel which is of the same color as the defective pixel and is adjacent to the defective pixel, and realizes a pseudo redundancy of the pixels.

### BACKGROUND OF THE INVENTION

1. Field of the Invention

The present invention generally relates to detective pixel correction methods and semiconductor devices, and more particularly to a defective pixel correction method for correcting defective pixels of an image pickup device and to a semiconductor device employing such a defective pixel correction method.

2. Description of the Related Art

Recently, image pickup devices (or imaging devices) are used in electronic apparatuses such as portable telephones, and the demand for CCDs, CMOS image sensors and the like is increasing. On the other hand, the number of pixels of the image pickup device has increased from 300,000 pixels to 2,000,000 pixels and there are demands to further increase the number of pixels to 3,000,000 pixels.

As the number of pixels of the image pickup device increases, the proportion of defective pixels also increases. Particularly in the case of a color image pickup device, the proportion of the defective pixels tends to increase as the number of pixels increases, due to the manufacturing error in the filters (or masks) that identify the colors, the manufacturing inconsistencies of the processes, dust or foreign particles, flaws or scratches, leaks and the like that increase with the increase in the number of pixels.

Methods of correcting the defective pixels by an electrical correction process or the like have been proposed in Japanese Laid-Open Patent Applications No. 7-143403, No. 10-322603 and No. 2004-64517.

Conventionally, since the proportion of the defective pixels increases as the number of pixels of the image pickup device increases, there was a problem in that it is difficult to improve the production efficiency of the image pickup device while maintaining the quality of the image pickup device.

### SUMMARY OF THE INVENTION

Accordingly, it is a general object of the present invention to provide a novel and useful defective pixel correction method and semiconductor device, in which the problem described above are suppressed.

Another and more specific object of the present invention is to provide a defective pixel correction method and a semiconductor device, which can improve the production efficiency of the image pickup device while maintaining the quality of the image pickup device, even when the number of pixels of the image pickup device increases.

Still another object of the present invention is to provide a defective pixel correction method comprising selecting, in place of a defective pixel within a pixel part of an image pickup device, a pixel which is of the same color as the defective pixel and is adjacent to the defective pixel; and realizing a pseudo redundancy of the pixels.

According to the defective pixel correction method of the present invention, it is possible to improve the production efficiency of the image pickup device while maintaining the quality of the image pickup device, even when the number of pixels of the image pickup device increases.

A further object of the present invention is to provide a semiconductor device comprising a pixel part configured to pickup an image, including a plurality of pixels arranged in an X-direction and a Y-direction which is perpendicular to the X-direction; and a driving part configured to select a pixel within the pixel part, wherein the driving part drives one of two mutually adjacent pixels of the same color, forming a pair, in place of the other of the two mutually adjacent pixels, in response to a selection signal. According to the semiconductor device of the present invention, it is possible to improve the production efficiency of the semiconductor device which forms an image pickup device, for example, while maintaining the quality of the image pickup device, even when the number of pixels of the image pickup device increases.

Other objects and further features of the present invention will be apparent from the following detailed description when read in conjunction with the accompanying drawings.

### BRIEF DESCRIPTION OF THE DRAWINGS

FIG. 1 is a plan view showing a layout of a pixel part of a first embodiment of a semiconductor device according to the present invention;

FIG. 2 is a circuit diagram showing an important part of the first embodiment of the semiconductor device according to the present invention;

FIG. 3 is a flow chart for explaining a test of the pixel part of the semiconductor device;

FIG. 4 is a plan view showing a layout of a pixel part of a second embodiment of the semiconductor device according to the present invention; and

FIG. 5 is a circuit diagram showing an important part of the second embodiment of the semiconductor device according to the present invention.

### DESCRIPTION OF THE PREFERRED EMBODIMENTS

In the present invention, a pixel of the same color as a defective pixel within a pixel part of an image pickup device is made selectable in place of the defective pixel, so as to realize a pseudo redundancy of the pixels. Accordingly, even when the number of pixels of the image pickup device increases, it is possible to improve the production efficiency of the image pickup device while maintaining the quality of the image pickup device.

A description will be given of each embodiment of a defective pixel correction method according to the present invention and a semiconductor device according to the present invention, by referring to the drawings.

### First Embodiment

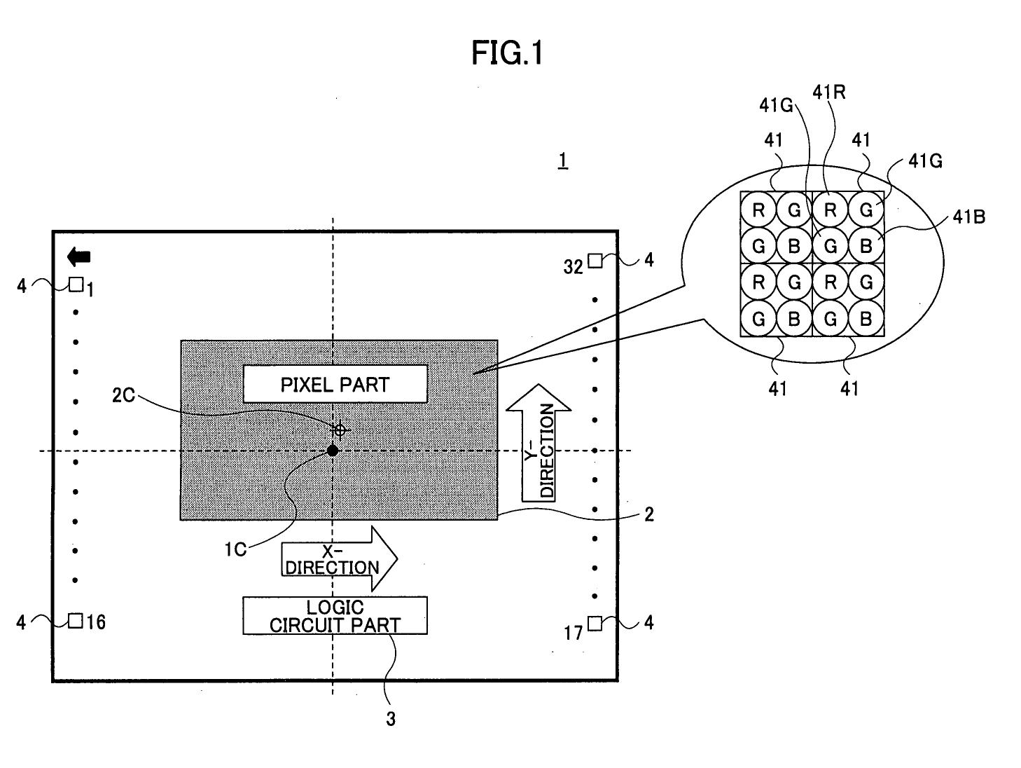

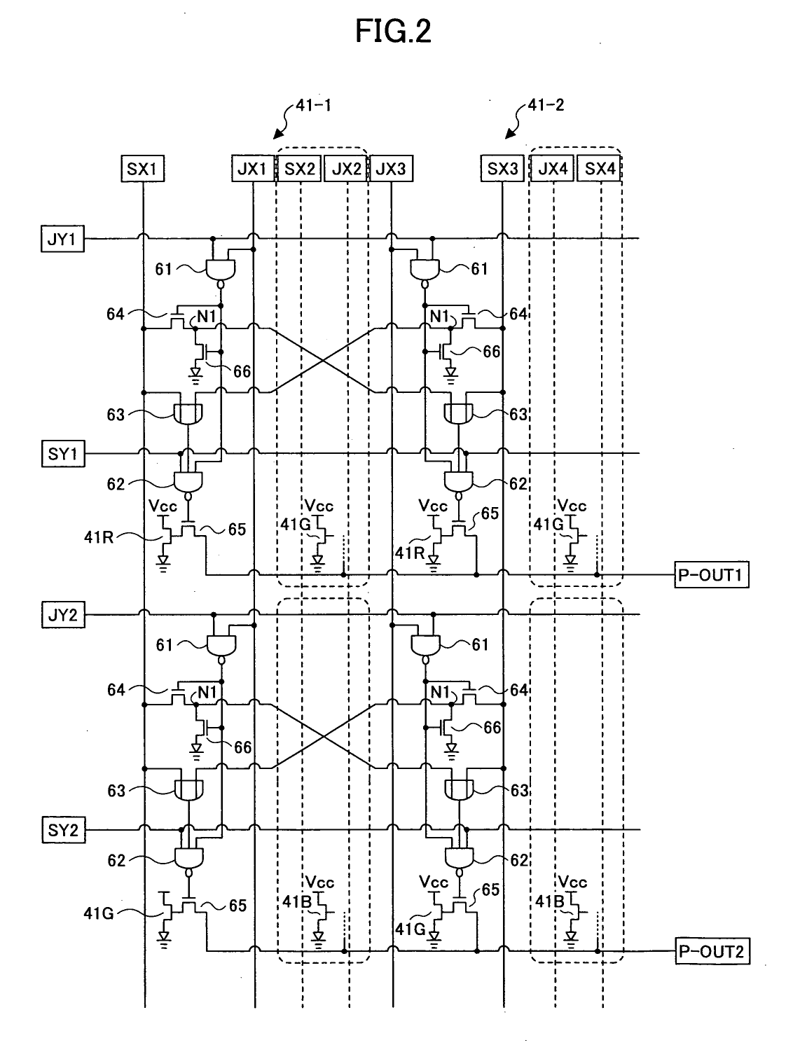

FIG. 1 is a plan view showing a layout of a pixel part of a first embodiment of the semiconductor device according to the present invention, and FIG. 2 is a circuit diagram showing an important part of this first embodiment of the semiconductor device according to the present invention. This first embodiment of the semiconductor device employs a first embodiment of the defective pixel correction method according to the present invention. The semiconductor device forms an image pickup device or an imaging device, for example.

A semiconductor device (or semiconductor chip) 1 shown in FIG. 1 has a pixel part 2, a logic circuit part 3 and a plurality of terminals 4. A plurality of photodiode parts 41 are arranged in both an X-direction and a Y-direction, which is perpendicular to the X-direction, within the pixel part 2. Each photodiode part 41 at least includes photodiodes 41R, 41G and 41B, as shown on an enlarged scale on the top right portion of FIG. 1. In this embodiment, each photodiode part 41 has one red photodiode 41R, two green photodiodes 41G, and one blue photodiode 41B. In other words, each photodiode part 41 forms a minimum unit of a photodetector element group made up of at least red, green and blue photodetector elements, and a plurality of such minimum units of the photodetector element group are arranged in both the X-direction and the Y-direction within the pixel part 2. In this embodiment, a center 1C of the semiconductor device 1 is located at a position different from a center 2C of the pixel part 2, but the center 1C of the semiconductor device 1 may of course match the center 2C of the pixel part 2.

It is assumed for the sake of convenience that the logic circuit part 3 includes a driving part, such as an X-coordinate selector and a Y-coordinate selector for driving the pixel part 2. However, the location of the logic circuit part 3 within the semiconductor device 1 is not limited to the position shown in FIG. 1, and the logic circuit part 3 may partially overlap the pixel part 2 (that is, partially overlap a lower portion of the pixel part 2) in the plan view. In addition, the locations of the pixel part 2, the logic circuit part 3 and the plurality of terminals 4 are not limited to the positions shown in FIG. 1, and it is possible to employ other known arrangements instead.

FIG. 2 shows, as one example, two photodiode parts (that is, the minimum units of the photodetector element group) 41-1 and 41-2 that are mutually adjacent in the X-direction and the driving parts of the photodiode parts 41-1 and 41-2. Since the structure of the driving part with respect to the photodiode part is the same for each of the photodiode parts, the driving parts for one of the green photodiodes 41G and the blue photodiode 41B within each of the photodiode parts 41-1 and 41-2 are surrounded by dotted lines in FIG. 2 and the illustration of the structure thereof will be omitted for the sake of convenience.

The driving part with respect to each of the photodiodes 41R, 41G and 41B includes NAND circuits 61 and 62, an OR circuit 63, PMOS transistors 64 and 65, and an NMOS transistor 66 that are connected as shown in FIG. 2. In FIG. 2, Vcc denotes a power supply voltage.

Between the two photodiode parts 41-1 and 41-2 that are mutually adjacent in the X-direction, a node N1 connecting the transistors 64 and 66 within one of the driving parts with respect to the photodiodes of the same color is connected to one of input terminals of the OR circuit 63 within the other of the driving parts, and in addition, one of input terminals of the OR circuit 63 within the one of the driving parts is connected to a node N1 connecting the transistors 64 and 66 within the other of the driving parts.

Pixel selection signals SX1, SX2, SY1 and SY2 are input to the photodiode part 41-1, and pixel selection signals SX3, SX4, SY1 and SY2 are input to the photodiode part 41-2. Furthermore, selection signals JX1, JX2, JY1 and JY2 indicating a defective pixel is input to the photodiode part 41-1, and selection signals JX3, JX4, JY1 and JY2 indicating a defective pixel is input to the photodiode part 41-2. An output of the red photodiode 41R within each of the photodiode parts 41-1 and 41-2 is denoted by P-OUT1, an output of one of the green photodiodes 41G within each of the photodiode parts 41-1 and 41-2 is denoted by P-OUT1, an output of the other of the green photodiodes 41G within each of the photodiode parts 41-1 and 41-2 is denoted by P-OUT2, and an output of the blue photodiode within each of the photodiode parts 41-1 and 41-2 is denoted by P-OUT2.

If no defective pixel exists within the photodiode parts 41-1 and 41-2 and the red photodiode 41R within the photodiode part 41-1 is to be selectively driven, for example, the pixel selection signals SX1 and SY1 are both “1”, the other pixel selection signals SX2 through SX4 and SY2 are all “0”, and the selection signals JX1 through JX4, JY1 and JY2 are all “0”. Accordingly, the PMOS transistor 65 within the driving part with respect to the red photodiode 41R of the photodiode part 4101 turns ON, and the output of this red photodiode 41R is obtained as the output P-OUT1. On the other hand, the PMOS transistor 65 within the driving part with respect to the red photodiode 41R of the photodiode part 41-2 turns OFF, and the output of this red photodiode 41R is not obtained as an output. A similar operation is carried out when no defective pixel exists within the photodiode parts 41-1 and 41-2 and the green photodiode 41G or the blue photodiode 41B within the photodiode part 41-1 is to be selectively driven, for example.

On the other hand, the selection signals JX1 and JY1 are set to “1” when the red photodiode 41R within the photodiode part 41-1, for example, is a defective pixel. In this case, when the red photodiode 41R within the photodiode part 41-1 is to be selectively driven, an output of the NAND circuit 61 within the driving part with respect to the red photodiode 41R of the photodiode part 41-1 makes a transition from “1” to “0”, the PMOS transistor 64 within this driving part makes a transition from an OFF state to an ON state, the NMOS transistor 66 within this driving part makes a transition from an OFF state to an ON state, and the pixel selection signal SX1=1 is supplied to the OR circuit 63 within the driving part with respect to the red photodiode 41R of the photodiode part 41-2. In addition, an output of the NAND circuit 62 within the driving part with respect to the red photodiode 41R of the photodiode part 41-1 makes a transition from “1” to “0”, the PMOS transistor 65 within this driving part makes a transition from an ON state to an OFF state, and the output pixel data (data of SX1) of this red photodiode 41R is blocked. Furthermore, an output of the OR circuit 63 within the driving part with respect to the red photodiode 41R of the photodiode part 41-2 makes a transition from “1” to “0”, the PMOS transistor 65 of this driving part makes a transition from an OFF state to an ON state, and the output pixel data (data of SX1) of the is red photodiode 41R is obtained as a valid output P-OUT1.

Next, even if the pixel selection signal SX1 is set to “0” and the pixel section signal SX3 is set to “1”, for example, the output of the OR circuit 63 is maintained to “1” within the driving part with respect to the red photodiode 41R of the photodiode part 41-2, and the PMOS transistor 65 within this driving part is maintained to the ON state, thereby maintaining the output pixel data of this red photodiode 41R valid. Accordingly, in the case where the pixel selection signals JX1 and JY1 are both “1”, the output pixel data of the red photodiode 41R within the photodiode 41-2 can be obtained as the output P-OUT1 by setting the pixel selection signal SX1 to “0” and the pixel selection signal SX3 to “1”.

The signal values of the pixel selection signals SX1 through SX4, SY1 and SY2 may be set by a known method depending on the sequence in which the output of the pixel part 2 is to be read. On the other hand, the signal values of the selection signals JX1 through JX4, JY1 and JY2 may be set depending on the defective pixels within the pixel part 2. The defective pixel is detected when the pixel part 2 is tested, and the selection signals JXi and JYj for selecting the detected deflective pixel may be set to “1” by utilizing a fuse (not shown) or a ROM (not shown) provided within the semiconductor device 1, where i and j are integers.

The operation of the driving part with respect to the green diode 41G within each of the photodiode parts 41-1 and 41-2 and the operation of the driving part with respect to the blue photodiode 41B within each of the photodiode parts 41-1 and 41-2 may be carried out similarly to the above described operation of the driving part with respect to the red photodiode 41R, and a description thereof will be omitted.

The operation of the driving part with respect to each of the photodiodes 41R, 41G and 41B within two photodiode parts 41 that are mutually adjacent in the Y-direction may readily be understood from the above described operation of the driving part with respect to each of the photodiodes 41R, 41G and 41B within the two photodiode parts 41-1 and 41-2 that are mutually adjacent in the X-direction, and thus, illustration and description thereof will be omitted.

Accordingly, by selecting, in place of the defective pixel within the pixel part of the semiconductor device 1, the pixel which is of the same color as the defective pixel and is adjacent to the defective pixel, it is possible to realize a pseudo redundancy of the pixels. Hence, even if the number of pixels of the pixel part 2 increases and becomes large, it is possible to improve the production efficiency while maintaining the quality of the semiconductor device 1, as long as the defective pixels are not generated consecutively.

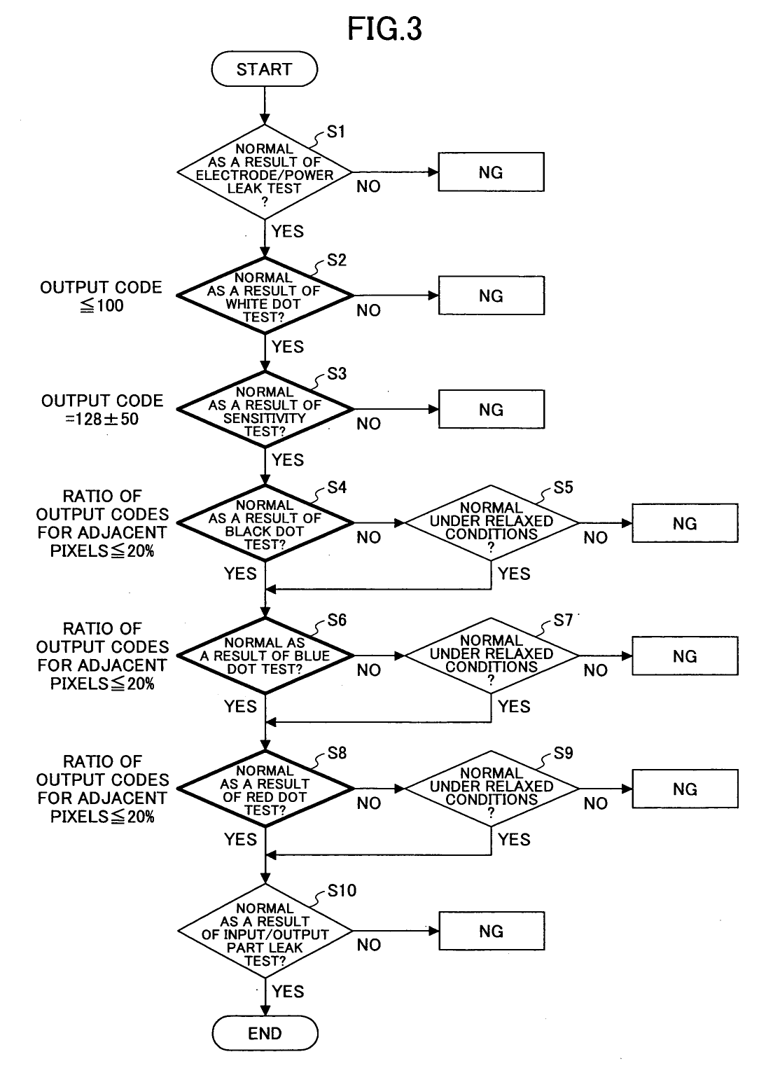

FIG. 3 is a flow chart for explaining a test of the pixel part 2 of the semiconductor device 1. In this embodiment, each photodiode part 41 has two green photodiodes 41G, and for this reason, it is assumed for the sake of convenience that the test is carried out with reference to the green color. In addition, it is assumed that an 8-bit output code, that may take code values “0” through “255”, is output from the pixel part 2 of the semiconductor device 1.

In FIG. 3, a step S1 tests the terminals (or electrodes) 4 and the power leak, and decides whether or not both are normal. If the electrical connection of the terminals 4 is defective or the power leak is generated, the decision result in the step S1 becomes NO, and it is judged that the semiconductor device 1 is defective (NG: No Good). If the decision result in the step S is YES, a step S2 carries out a white dot test to decide whether or not the pixel part 2 is normal. The white dot test confirms that no leak is generated in the pixels by confirming that the code value of the output code of all of the pixels within the pixel part 2 is “100” or less in a completely dark state.

If the decision result in the step S2 is YES, a step S3 carries out a sensitivity test to decide whether or not the pixel part 2 is normal. The sensitivity test confirms that the sensitivity of the pixel part 2 is normal by confirming that the code value of the output code of the pixels in a central portion of the pixel part is “128±50” when white light is irradiated on the pixel part 2, if an average value of the brightness of the white light is represented by a code value “128”, for example. If the decision result in the step S2 or S3 is NO, it is judged that the semiconductor device 1 is defective.

If the decision result in the step S3 is YES, a step S4 carries out a black dot test to decide whether or not the pixel part 2 is normal. The black dot test obtains a ratio by dividing the output code value of a target pixel that is output when the white light is irradiated on the pixel part 2 by an average output code value of several pixels located several pixels away in the X-direction or Y-direction from the position of the target pixel, and obtains a percentage of this ratio, so as to confirm that the pixel part is normal by confirming that the percentage of this ratio is 20% or less, for example. If the decision result in the step S4 is NO, a step S5 relaxes or reduces the judging reference used in the step S4 to ½ the original reference value with respect to a region in the peripheral portion of the pixel part 2 and carries out the black dot test similarly to the step S4 but under the relaxed conditions.

If the decision result in the step S4 or S5 is YES, a step S6 carries out a blue dot test to decide whether or not the pixel part 2 is normal. The blue dot test obtains a ratio by dividing the blue of the output code value of a target blue pixel that is output when the white light is irradiated on the pixel part 2 by an average output code value of several blue pixels located several pixels away in the X-direction or Y-direction from the position of the target blue pixel, and obtains a percentage of this ratio, so as to confirm that the pixel part is normal by confirming that the percentage of this ratio is 20% or less, for example. If the decision result in the step S6 is NO, a step S7 relaxes or reduces the judging reference used in the step S6 to ½ the original reference value with respect to a region in the peripheral portion of the pixel part 2 and carries out the blue dot test similarly to the step S6 but under the relaxed conditions.

If the decision result in the step S6 or S7 is YES, a step S8 carries out a red dot test to decide whether or not the pixel part 2 is normal. The red dot test obtains a ratio by dividing the red of the output code value of a target red pixel that is output when the white light is irradiated on the pixel part 2 by an average output code value of several red pixels located several pixels away in the X-direction or Y-direction from the position of the target red pixel, and obtains a percentage of this ratio, so as to confirm that the pixel part is normal by confirming that the percentage of this ratio is 20% or less, for example. If the decision result in the step S8 is NO, a step S9 relaxes or reduces the judging reference used in the step S8 to ½ the original reference value with respect to a region in the peripheral portion of the pixel part 2 and carries out the red dot test similarly to the step S8 but under the relaxed conditions.

If the decision result in one of the steps S5, S7 and S9 is NO, it is judged that the semiconductor device 1 is defective. The steps S5, S7 and S9 are not essential and may be omitted.

If the decision result in the step S8 or S9 is YES, a step S10 carries out an input/output part leak test of the semiconductor device 1, so as to decide whether or not an input/output part of the semiconductor device 1 is normal. If the decision result in the step S10 is NO, it is judged that the semiconductor device 1 is defective. The test ends if the decision result in the step S10 is YES.

By carrying out the test described above, it is possible to detect the defective pixels within the pixel part 2 of the semiconductor device 1. The selection signals indicating the defective pixels, such as the selection signals JX1 through JX4, JY1 and JY2, may be set to select the defective pixels that are detected as a result of carrying out this test.

### Second Embodiment

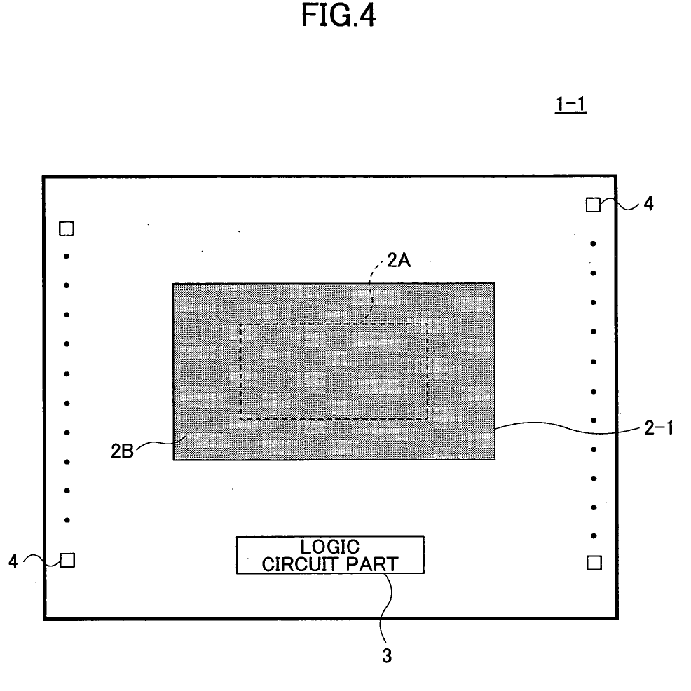

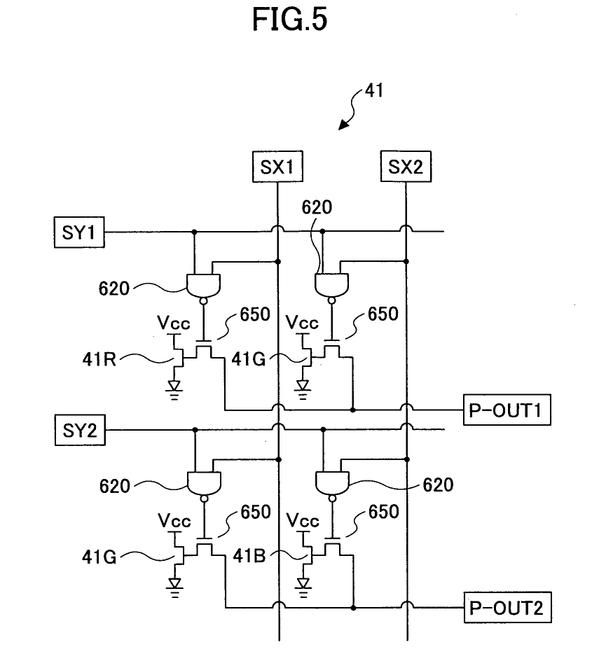

FIG. 4 is a plan view showing a layout of a pixel part of a second embodiment of the semiconductor device according to the present invention, and FIG. 5 is a circuit diagram showing an important part of this second embodiment of the semiconductor device according to the present invention. This second embodiment of the semiconductor device employs a second embodiment of the defective pixel correction method according to the present invention.

In the first embodiment described above, the pseudo redundancy of the pixels is realized with respect to all of the pixels within the pixel part 2 of the semiconductor device. On the other hand, in this second embodiment, the pseudo redundancy of the pixels is realized only with respect to the pixels within a region in a portion of the pixel part 2 of the semiconductor device 1.

In the case where the test irradiates light on the pixel part as in the case of the test described above in conjunction with FIG. 3, the light intensity within the region in a peripheral portion of the pixel part may be slightly lower than that within the region in a central portion of the pixel part. In this case, the judging reference used with respect to the test result may be relaxed or reduced compared to the original reference value with respect to the region in the peripheral portion of the pixel part. To the human eye, there is a tendency for the defective pixels within the region in the central portion of the pixel part to appear more conspicuous than the defective pixels within the region in the peripheral portion of the pixel part. Accordingly, the pseudo redundancy of the pixels may be realized only within the region in the central portion of the pixel part.

In a case where the defective pixels are generated within a specific region of the pixel part due to the manufacturing processes of the semiconductor device with a higher probability than that within other regions of the pixel part, the pseudo redundancy of the pixels may be realized only within this specific region of the pixel part.

In FIG. 4, those parts that are the same as those corresponding parts in FIG. 1 are designated by the same reference numerals, and a description thereof will be omitted. A pixel part 2-1 of a semiconductor device 1-1 shown in FIG. 4 is designed to realize the pseudo redundancy of the pixels only within a region 2A in the central portion of the pixel part 2-1. In other words, driving parts having a structure similar to that shown in FIG. 2 are provided within the region 2A of the pixel part 2-1.

On the other hand, no driving part having the structure for realizing the pseudo redundancy of the pixels is provided within a region 2B in the peripheral portion of the pixel part 2-1, and a driving part shown in FIG. 5 is provided. FIG. 5 shows, as an example, one photodiode part (that is, the minimum unit of the photodetector element group) 41 and the driving part thereof. In FIG. 5, those parts that are the same as those corresponding parts in FIG. 2 are designated by the same reference numerals, and a description thereof will be omitted.

In FIG. 5, the structures of the driving parts with respect to each of the photodiodes 41R, 41G and 41B are the same. The driving part with respect to each of the photodiodes 41R, 41G and 41B includes a NAND circuit 620 and a PMOS transistor 650 that are connected as shown in FIG. 5. If the pixel selection signals SX1 and SY1 are both “1” and the pixel selection signals SX2 and SY2 are both “0”, for example, the output pixel data of the red photodiode 41R within the photodiode part 41 may be obtained as an output P-OUT1. The output of the red photodiode 41R within the photodiode part 41 is indicated by P-OUT1, the output of one of the green photodiodes 41G within the photodiode part 41 is indicated by P-OUT1, the output of the other of the green photodiodes 41G within the photodiode part 41 is indicated by P-OUT2, and the output of the blue photodiode 41B within the photodiode part 41 is indicated by P-OUT2.

Accordingly, by selecting, in place of the defective pixel within the region 2A of the pixel part 2-1 of the semiconductor device 1-1, the pixel which is of the same color as the defective pixel and is adjacent to the defective pixel, it is possible to realize the pseudo redundancy of the pixels. Hence, even if the number of pixels of the pixel part 2-1 increases and becomes large, it is possible to improve the production efficiency while maintaining the quality of the semiconductor device 1-1, as long as the defective pixels are not generated consecutively. Moreover, since the pseudo redundancy of the pixels is not realized within the region 2B of the pixel part 2-1 of the semiconductor device 1-1, the structure of the pixel part 2-1 becomes simpler by a corresponding amount.

This application claims the benefit of a Japanese Patent Application No. 2006-081434 filed Mar. 23, 2006, in the Japanese Patent Office, the disclosure of which is hereby incorporated by reference.

Further, the present invention is not limited to these embodiments, but various variations and modifications may be made without departing from the scope of the present invention.

What is claimed is:

1. A defective pixel correction method comprising:
selecting, in place of a defective pixel within a pixel part of an image pickup device, a pixel which is of the same color as the defective pixel and is adjacent to the defective pixel; and
realizing a pseudo redundancy of the pixels.

2. The defective pixel correction method as claimed in claim 1, wherein the pixel part includes a plurality of pixels arranged in an X-direction and in a Y-direction which is perpendicular to the X-direction, and the pixel selected in place of the defective pixel is adjacent to the defective pixel along the X-direction.

3. The defective pixel correction method as claimed in claim 1, wherein the pixel part includes a plurality of pixels arranged in an X-direction and in a Y-direction which is perpendicular to the X-direction, and the pixel selected in place of the defective pixel is adjacent to the defective pixel along the Y-direction.

4. The defective pixel correction method as claimed in claim 1, wherein minimum units of a photodetector element group comprising at least red, green and blue photodetector elements are arranged in an X-direction and in a Y-direction which is perpendicular to the X-direction, and the pixel selected in place of the defective pixel belongs to a minimum unit that is adjacent to a minimum unit to which the defective pixel belongs.

5. The defective pixel correction method as claimed in claim 1, wherein the pixel is selected in place of the defective pixel only within a region in a portion of the pixel part.

6. The defective pixel correction method as claimed in claim 5, wherein the region in the portion of the pixel part is a region in a central portion of the pixel part.

7. The defective pixel correction method as claimed in claim 1, comprising:
carrying out a test to detect the defective pixel within the pixel part; and
generating a selection signal when one of two mutually adjacent pixels of the same color, forming a pair, is detected as the defective pixel,
wherein the selection signal selects the defective pixel in place of the other of the two mutually adjacent pixels.

8. The defective pixel correction method as claimed in claim 7, comprising:
supplying the selection signal to the driving part of the image pickup device using a ROM or a fuse.

9. A semiconductor device comprising:
a pixel part configured to pickup an image, including a plurality of pixels arranged in an X-direction and a Y-direction which is perpendicular to the X-direction; and
a driving part configured to select a pixel within the pixel part,
wherein the driving part drives one of two mutually adjacent pixels of the same color, forming a pair, in place of the other of the two mutually adjacent pixels, in response to a selection signal.

10. The semiconductor device as claimed in claim 9, wherein the two mutually adjacent pixels are adjacent to each other along the X-direction.

11. The semiconductor device as claimed in claim 9, wherein the two mutually adjacent pixels are adjacent to each other along the Y-direction.

12. The semiconductor device as claimed in claim 9, wherein:
the pixel part includes minimum units of a photodetector element group comprising at least red, green and blue photodetector elements, arranged in the X-direction and in the Y-direction; and
the one of the two mutually adjacent pixels driven in place of the other of the two mutually adjacent pixels belongs to a minimum unit that is adjacent to a minimum unit to which the other of the two mutually adjacent pixels belongs.

13. The semiconductor device as claimed in claim 9, wherein the driving part drives the one of the two mutually adjacent pixels in response to the selection signal only within a region in a portion of the pixel part.

14. The semiconductor device as claimed in claim 13, wherein the region in the portion of the pixel part is a region in a central portion of the pixel part.

15. The semiconductor device as claimed in claim 9, wherein the selection signal indicates that the one of the two mutually adjacent pixels that is to be driven is a defective pixel.

16. The semiconductor device as claimed in claim 9, further comprising:
a signal source configured to supply the selection signal to the driving part,
wherein the signal source is formed by a ROM or a fuse.
